(19) United States
(12) Patent Application Publication
(10) Pub. No.: US 2009/0314921 A1
(43) Pub. Date: Dec. 24, 2009

(54) ASSEMBLIES AND METHOD FOR SECURING SURFACE MOUNTED ARTICLES TO ACCOMMODATE APPLIED LOADS

(76) Inventor: Richard Gould, New South wales (AU)

Correspondence Address: STITES & HARBISON PLLC, 1199 NORTH FAIRFAX STREET, SUITE 900, ALEXANDRIA, VA, 22314, US

(21) Appl. No.: 12/281,791

(22) PCT Filed: Mar. 9, 2007
(86) PCT No.: PCT/AU07/00291

§ 371 Date: Feb. 17, 2009

(30) Foreign Application Priority Data
Mar. 9, 2006 (AU) 2006901216
Jun. 29, 2006 (AU) 2006903491

(51) Int. Cl. F16M 13/00

(52) U.S. Cl. 248/636

(57) ABSTRACT

An assembly for dissipating energy generated by a force applied to an article fixed to a ground surface, the assembly comprising at least one expandable member having a first part which is fastened to the ground surface, at least a second part fixed to said device, the expandable member including means to enable expansion along at least one dimension in response to an impact load applied to the article to which the member is attached; the expansion of the expandable member allowing dissipation of energy generated by a loading to the article; thereby restraining the device from complete separation from fastening said at least one bracket.

### BACKGROUND

The present invention relates to the physical security of articles that are mounted on surfaces More particularly, the invention relates to an assembly which allows energy dissipation when an article is under load to avoid separation of the article from an anchorage. The invention further relates to a connection assembly which facilitates energy dissipation when an article such as but not limited to safes or vending equipment and Automatic Teller Machines (ATM's), is subject to unwanted impact loading such as in the case of vehicle impact. More particularly the invention relates to an energy absorbing assembly and method for securing a ground mounted article such as but not limited to an ATM or safe, used to hold cash or valuables ATM and the like and which is capable of withstanding high impact loads and particularly horizontally applied to loads.

The invention further relates to an assembly which allows a ground mounted article such as a safe or ATM to resist complete removal from its anchorage by dissipating applied energy through the assembly and allowing the device to undergo some displacement as a means of dissipating the energy of impact thereby providing resistance to separation of the article from its anchorage. Although the invention will be described with primary reference to its applicant to ATM machines, it will be appreciated that the apparatus and assembly of the invention is adaptable to other articles intended for rigid attachment to a surface and which ideally must withstand unwanted impact loads.

### PRIOR ART

Articles for storing valuables such as safes and ATM's are often mounted on a ground surface with secure anchor bolts to prevent removal. ATM's which usually contain large amounts of cash are particularly vulnerable in smash and grab raids on premises in which such ATM's are located. The frequency of vandalism of ATM's using vehicles is increasing necessitating a solution to make such devices more secure and with a greater ability to withstand heavy vehicle impact. To date there has been no adequate means to enable such floor mounted devices to satisfactorily resist impact loads.

ATM's machines have a rigid body made of steel or similar. They are usually rigidly fixed to a ground surface usually of concrete or other hard stand surface with an ‘in ground’ expanding type bolt such as a locksain or dynabolt. The use of a plurality of expanding bolts secures the ATM to the hard stand surface and provides some limited security against theft.

Other measures employed to secure an ATM to a plinth base from under the ATM is a chain assembly which locks down ATM's using additional bolts and/or ‘chemical’ bolts. The chain assembly has a finite length and does not expand upon impact or gradually dissipate energy. Rather any energy dissipation is abrupt once the chain is taut. The general approach security of ATM's has been to locate them in secure positions such as at the rear of a premises to remove ready theft access. There is a long felt want in the industry to improve the security of ATM's, security safes and particularly ground mounted safes which have poor resistance to horizontal loadings such as those which might be applied in a criminal ram raid.

In recent times the employment by criminals of mechanical devices such as a vehicle, truck, tractor, hydraulics by thieves has been used to disengage ATM cabinets from the ground. The ‘Ram Raid’ as it has become known is known for its quick execution and is a fast growing target of criminals along with safes and vending machines.

Sudden and violent impacts with a vehicle as in ‘ram raid's” uses the rigid ATM body when being tipped over to provide the necessary leverage to extract fastening expander bolts connecting it to the ground. When the ATM is successfully disengaged from the ground thieves can load the machine into a vehicle and depart the area with the ATM. This allows the thieves, in private, to cut open the ATM and retrieve the enclosed cash or valuable contents.

At present there is no satisfactory means available to fully secure such articles as floor mounted ATM's, safes and vending machines particularly from unwanted impact load applied in such activities as ram raids.

### INVENTION

The present invention provides an assembly and method for enhancing the physical security of articles such as those used to hold cash or valuables, such as an ATM (automatic teller machine), safe or vending equipment. More particularly the invention provides an energy absorbing assembly and method for securing a ground mounted article such as but not limited to a safe, ATM and the like and which is capable of withstanding high impact loads and particularly horizontally applied loads.

This present invention is designed to withstand and absorb much of the horizontal load energy applied by vehicle ‘ram raid’ attacks which would otherwise shear off the article from its anchorages. The invention also provides resistance to other loadings such as rotational moments and combined rotational moments and shear loadings.

One object of the assembly and apparatus of the present invention is to provide energy dissipation when a fixed article such as an ATM is subject to impact which reduces loading that would in the absence of such energy dissipation result in unwanted separation of the article from its anchorages.

In its broadest form the present invention comprises:

an assembly for securing an article to a surface, the assembly comprising:
at least one connecting member each including means at a first location to secure said member to said surface and means at a second location to secure said member to said article;
the connecting member having means to dissipate energy in the event of a load on said article, the energy dissipation means allowing the connecting member to extend under said impact thereby restraining the article from separation from said connecting member.

Preferably each connecting member moves upon an impact load on said article between a first state in which the connecting member is unextended and a second state in which the connecting member is extended in at least one direction as the article moves.

Preferably, each connecting member is fastened at the first location to a ground surface and via said second location to the article.

The connecting member may take many forms allowing various options for the construction of the energy dissipation assembly. For example the connecting member may be a series of brackets or plates or any combination of same. The connecting member may be one bracket or one plate. Where a bracket is used, the bracket will preferably includes at least one or a series of corrugations formations such as a V shaped formation or folds intermediate opposite ends of each brackets which are capable of expansion under load such as when in tension.

Each bracket is capable of a displacement in a direction which allows a rotation and/or stewing of the article away from a line of applied load. The connection member is capable of displacement vertically laterally at the sane time. The connecting member may also be a helical spiral or a plate assembly having at least one plate providing connection between the article and the ground.

According to one embodiment, the ground engaging plate has a cut region which forms a deformable portion of the plate and which is capable of movement out of the plane of the plate when an impact load is applied to the article connected to the plate. The article is preferably connected to the deformable portion via the base of the article. The fasteners may be expendable bolts such as locksains or dynabolts but other fastening means may be employed.

In another broad form the present invention comprises:

an assembly for dissipating energy generated by a force applied to an article fixed to a ground surface via the assembly,
the assembly comprising at least one connecting member having a first part which is fastened to the ground surface,
at least a second part fixed to said device,
the connecting member including means to enable the member to expand along at least one dimension in the event of an impact load applied to the article to which it is attached; said expansion means allowing dissipation of energy generated by a Loading to the device; thereby restraining the device from separation from said at least one connecting member.

In one broad form the present invention comprises:

an assembly for dissipating energy generated by a force applied to an article fixed to a ground surface,
the assembly comprising at least one expandable member having a first part which is fastened to the ground surface,
at least a second part fixed to said device,
the expandable member including means to enable expansion along at least one dimension in response to an impact load applied to the article to which the member is attached; the expansion of the expandable member allowing dissipation of energy generated by a loading to the article; thereby restraining the device from complete separation from fastening said at least one bracket.

According to a preferred embodiment said expandable member comprises, at least one corrugation intermediate the ends of said member. According to an alternative embodiment the expansion means comprises a series, of corrugations between said first and second ends of each said at least one bracket. Preferably, the bracket is capable of displacement in a direction parallel to the direction of an applied load. According to one embodiment the bracket allows a rotational component of the displacement of the device on impact.

In another broad form the present invention comprises:

an energy absorbing bracket for dissipating energy generated by a force applied to an article fixed to a ground surface by the bracket,
the bracket comprising a first part at one end which is fastened to the ground surface, a second part at a second end fixed to said device,
the bracket including means to enable the bracket to displace along at least one if its dimensions in the event of an impact load applied to the article secured by the bracket; said displacement allowing dissipation of energy generated by a loading to the article; thereby restraining the article from separation from the bracket and from said ground surface.

In another broad form of a method aspect form the present invention comprises:

a method for allowing a ground mounted article to absorb energy generated by a force applied to the article when fixed to a ground surface,
the method comprising the steps of:
a) taking at least one bracket member having a first connection means at a first end,
b) fixing the first end to the ground surface,
c) taking a second end of the at least one bracket;
d) fixing the second end to said article,
e) arranging the bracket so that the bracket can expand along at least one dimension in the event of an impact load applied to the device; said expansion allowing dissipation of energy generated by a loading to the article; thereby restraining the article from separation from said at least one bracket member.

According to a preferred embodiment the method comprises the further step before fixation of the at least one bracket of introducing a series of corrugations or folds in the bracket between said first and second ends of each said at least one bracket thereby allowing the bracket to displace in a direction parallel to or normal to the direction of an applied load.

In another broad form the present invention comprises:

an energy absorbing bracket for dissipating energy generated by a force applied to an article fixed to a ground surface by the bracket,
the bracket comprising a first part at one end which is fastened to the ground surface, a second part at a second end fixed to said device,
the bracket including means to enable the bracket to expand through at least one if its dimensions at said intermediate portion in the event of an impact load applied to the article secured by the bracket; said expansion allowing dissipation of energy generated by a loading to the device; thereby restraining the article from complete separation from anchorages.

According to one embodiment the intermediate portion of the bracket includes a series of folds or corrugations, which tend to unfold consequent upon impact on said device.

In another broad form the present invention comprises:

a kit for fixation to a ground mounted article to enable it to absorb and dissipate energy generated by a force applied to the article when the article is fixed to a support surface,
the kit comprising at least one connecting member having a first part which is fixable to the ground surface, and a second fixable to said device,
the connection member including means to enable the bracket to expand along at least one dimension in the event of an impact load applied to the article;
fasteners for fastening the bracket member to the article and to the ground;
a housing for covering the connection member device once said brackets are installed.

### BRIEF DESCRIPTION OF DRAWINGS

The present invention will now be described according to preferred but non limiting embodiments and with reference to the accompanying illustrations wherein:

FIG. 1 shows a typical ATM machine with operator control panel layout and including a cover plate covering connection assemblies.

FIG. 2 shows an energy dissipation connection assembly ram raid energy absorbing assembly with the cover plate removed to reveal the components of the devise.

FIG. 3 shows an end view profile of a connecting member with expandable folds according to one embodiment.

FIG. 4 shows an end view profile of a connecting member with expandable folds according to another embodiment.

FIG. 5 shows an end profile of a cover plate providing a housing for the connecting members of FIGS. 3 and 4.

FIG. 6 shows an enlarged view of the connecting member of FIG. 3

FIG. 7 shows an enlarged view of a cover plate housing which houses connecting members of FIGS. 3 and 4.

FIG. 8 shows the connecting members of FIGS. 3 and 4 fully expanded.

FIG. 9 shows a typical ATM container fitted with two connecting members and cover housings.

FIG. 10 shows an ATM cabinet with a connecting member reacting in response to a load applied to the ATM.

FIG. 11 shows a side elevation view of an ATM machine showing a cover housing.

FIG. 12 shows an ATM machine reacting to an applied frontal load and showing a connecting member reacting to the impact by expansion.

FIG. 13 shows a connecting member fitted to a wall of an abbreviated article showing ground fastener.

FIG. 14 shows an enlarged view of an abbreviated ATM displaced in response to an impact load and with connecting member expanding to dissipate energy.

FIG. 15 shows a perspective view of a connecting member partially expanded.

FIG. 16 shows a typical expansion bolt used as an anchorage for the connecting member fitted to the ATM and ground surface.

FIG. 17 shows an enlarged view of an abbreviated ATM with an expandable connecting member fitted to a ground surface and ATM.

FIG. 18 shows a security bracket used to cover and secure a ground mounted expansion bolt.

FIG. 19 shows an end elevation view of a bracket according to one preferred embodiment.

FIG. 20 shows a perspective exploded view of the bracket of FIG. 19 and adjacent cover plate.

FIG. 21 shows a side elevation view of a connecting bracket assembly fitted to an ATM via a support plinth.

FIG. 22 shows a perspective view of the connecting bracket assembly.

FIG. 23 shows the connecting bracket assembly isolated from the support plinth.

FIG. 24 shows an exploded view of a connecting assembly formed from co operating plates for an ATM, according to an alternative embodiment.

FIG. 25 shows the arrangement of FIG. 24 partially assembled

FIG. 26 shows the arrangement of FIG. 25 fully assembled with ATM engaged with anchor plates.

FIG. 27 shows an enlarged view of a tab connection with energy dissipating tear bridges.

FIGS. 28 A & B shows a front view of an ATM machine reacting to impact load from a vehicle and mode of expansion of the connecting plate assembly.

FIG. 29 shows an enlarged front view of an ATM subject to lateral load with connecting plates under expansion.

FIG. 30 shows a side view of the arrangement of FIG. 29

### DETAILED DESCRIPTION

Further features and benefits will be apparent by reference to the drawings and ensuing detailed description of the preferred embodiments which disclose the best mode contemplated in carrying out the invention. The following description of the preferred embodiments is merely exemplary in nature and is not intended to limit the invention or its application or uses. With reference to the drawings, like numerals designate like and corresponding parts throughout

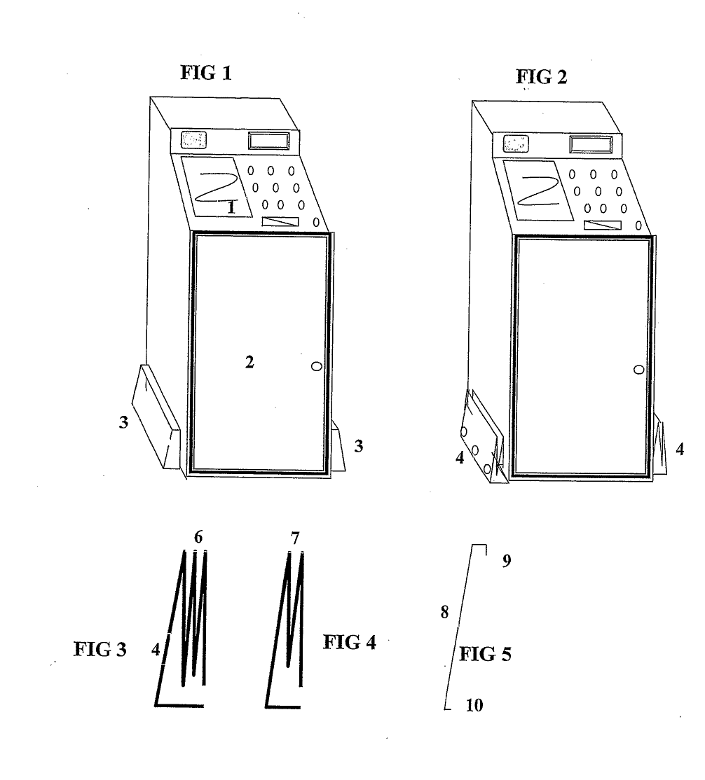

FIG. 1 shows an assembly 1 which comprises a typical Automatic Teller Machine (ATM) 2 as would for instance be installed in retail premises. ATM 2 shows a typical customer layout for providing cash withdraw facility. Assembly 1 further comprises an energy dissipation connection assembly 4 (see FIG. 2) located behind cover 3 fitted to the right and left hand sides of ATM 2. The installation of two assemblies 4 produces optimal security should the ATM cabinet suffer an impact such as from a ram raid.

FIG. 2 shows a ‘ram raid energy absorbing devise’ with the cover plate 3 removed to reveal the components of the assembly 4. FIG. 3 shows the profile of assembly 4 ram raid energy absorbing devise with three folds 6. The folds shown in this example are a concertina of folded metal of a suitable thickness to create a number of compressed aligned folds. The space collected between folds 6 allows expansion outward between the inner plates when stretched by such an event as a vehicle impact on the ATM container.

FIG. 4 shows an assembly 4 according to an alternative embodiment with profile of folds 7. This example uses less folds and hence inner plates and saves space in the final assembled configuration, but does not have the same expansion capacity as presented in FIG. 3.

FIG. 5 shows a profile of a cover plate 8 as an example of how the assemblies 4 would be covered from being damaged or tampered with. A return fold 9 secures the top from separation from the wall of the ATM 2. The return 10 allows a sealing from the environment and the outside floor.

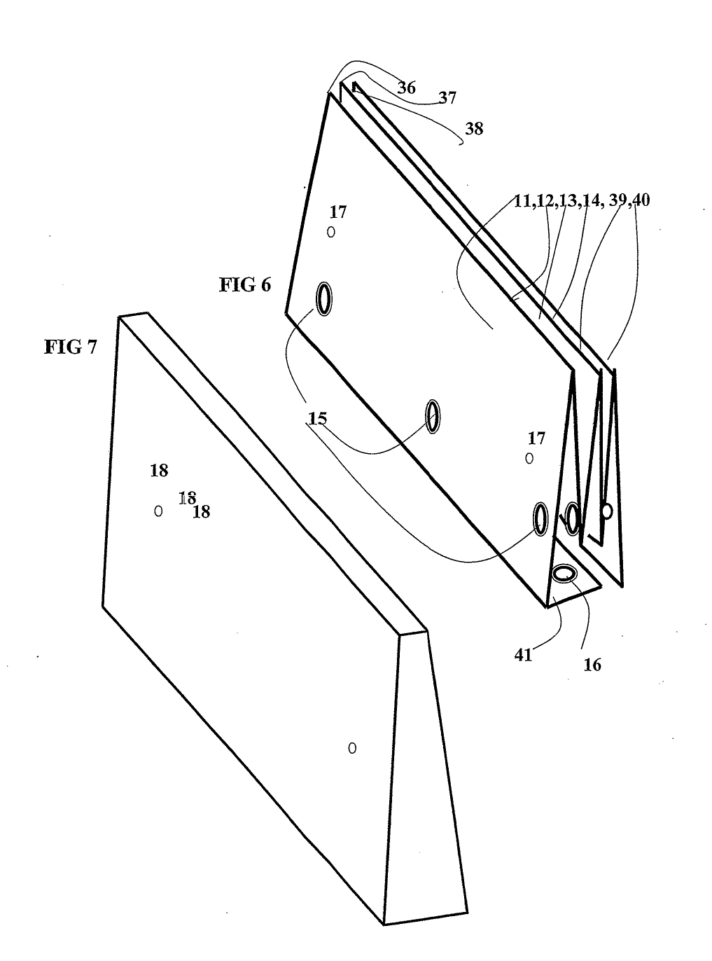

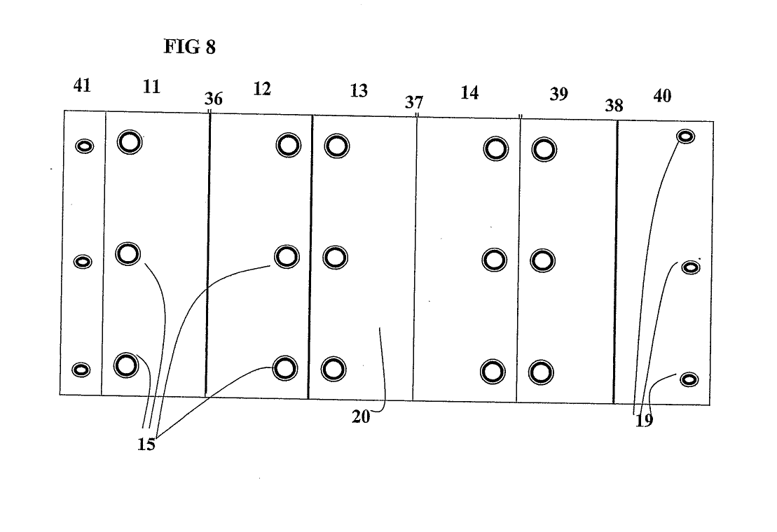

FIG. 6 shows an enlarged view of an energy dissipation assembly of the type shown in FIG. 3 ready for fitting to an ATM. Inner panels 11, 12,13,14, 39,40 41 are made from a folded piece or welded or stitched joined pieces of suitable material as shown FIG. 8. The inner panels 11, 12,13,14,39,41 are in this example compressed into this shape during the manufacturing process. Holes 15 are generally larger to provide access for bolts heads to pass through so to fix the energy dissipation assembly to the ATM body. Holes 16 are to provide a location to bolt the energy dissipation assembly to the ground. Holes 17 are to fit the cover plate of FIG. 7.

FIG. 7 shows an enclosure cover plate for the ‘ram raid energy absorbing devise’ 3 providing a cover 4 to prevent easy access to the components; that make up the energy dissipation assembly. Holes 18 are to allow a screw to fix the cover plate to the assembly.

FIG. 8 shows an example of an energy dissipation assembly plate 20 prior to folding into a complete configuration. This example shows the larger access holes 15 for allow tools such as a matching drive socket and bolt heads to pass through to the smaller 19 mounting points needed to fix the assembly to the ATM body. These smaller mounting holes may include additional material to provide a more secure fixing or reduce stress tearing by to impact of the vehicle. We show the inner panels 11,12,13,14,39, 41 and folds 36,37,38. As stated earlier the number of folds, size, form, fixings, material used and thickness etc. are adjustable to suit the application.

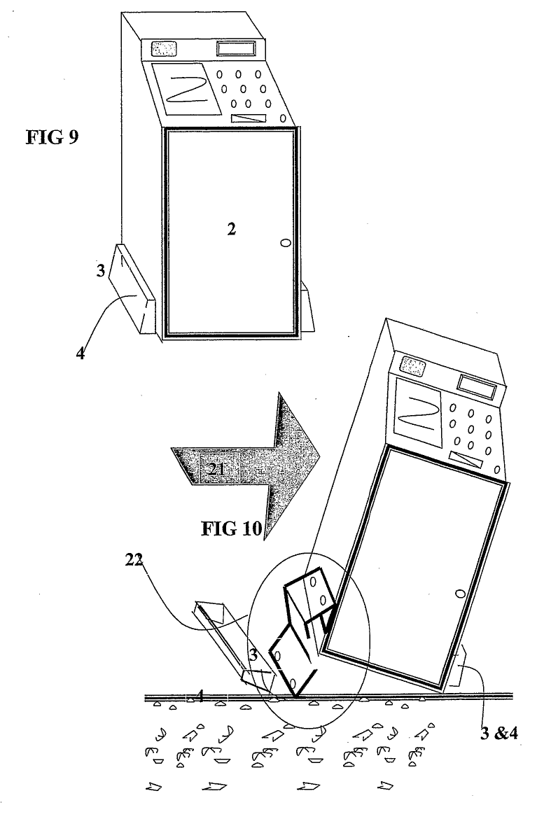

FIG. 9 shows an assembly similar that of FIG. 1 including ATM 2 fitted with two energy dissipation assemblies protected by cover plates 3.

FIG. 10 shows an ATM cabinet 2 after it has received an impact from a load applied in the direction of arrow 21. In this example the energy dissipation assembly 22 has extended out to absorb the energy of the impact. The energy dissipation assembly 4 under cover 3 also respond by bending to restrict the movement of the ATM 2. The cover plate 4 has fallen away as a result of the impact. At all times the ATM remains secured to the expandable energy dissipation assembly preventing theft.

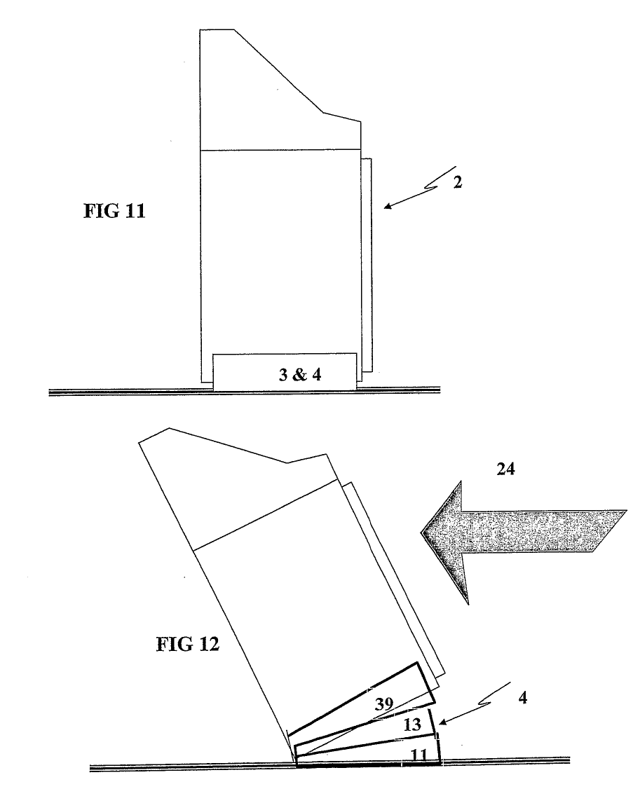

FIG. 11 shows aside elevation view of an ATM 2 fitted with two energy dissipation assemblies 4 (opposite side obscured) with the cover plates 3.

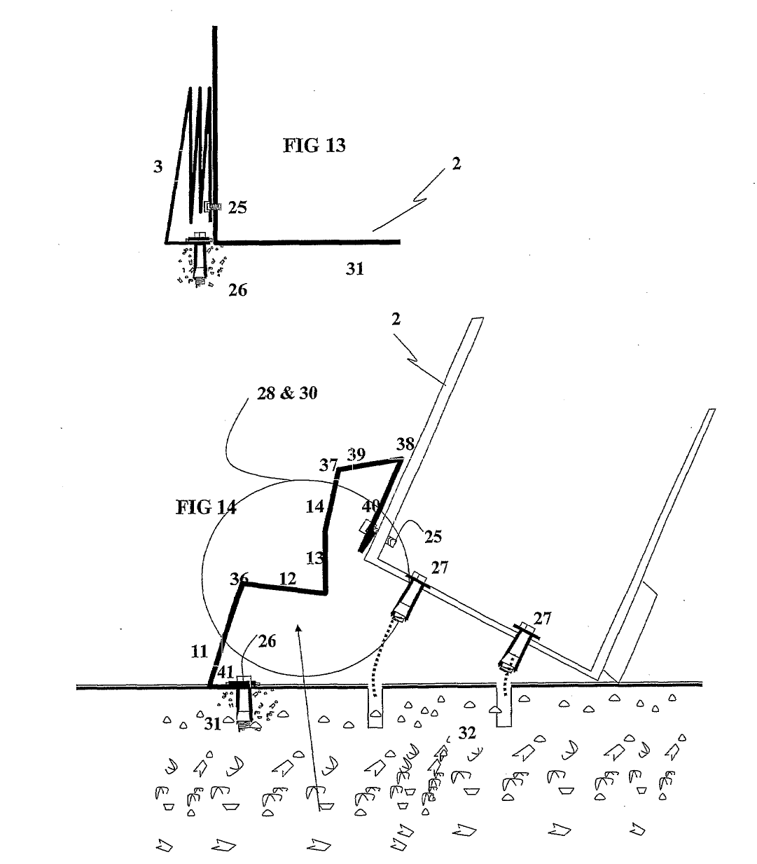

FIG. 12 shows an ATM 2 after it has received an impact from a load applied in the direction of arrow 24. In this example the energy dissipation assembly 4 both Left and Right allow the inner plates 11, (12, 13 obscured), 39, to expand at their folds thereby absorbing the energy of the impact.

FIG. 13 shows a energy dissipation assembly 4 without the cover plate 3 absent, to the side of an ATM partially abbreviated by a fixing bolt 25. Both ends of the folded inner plates are fixed. One side is attached to the ATM body with standard fixing bolts 25 and the other is fixed to the ground 31 using expansion bolts 26.

FIG. 14 shows the expansion of the inner plates 11, 12, 13, 14, 39, 40 when the ATM body 2 has been subject to impact load. These plates have been expanded by the energy of impact and leverage provided by the ATM body. During the impact energy stored in the vehicle's momentum is transferred into the ATM body. Such energy has and will cause an energy shock that can dislodge and eject the ATM cabinet from its normal internally fitted expander bolts 27.

The inner plates 11, 12, 13, 14 and 39 of the energy dissipation assembly 4 by the expansion will cause them to bend in an opposite direction from the applied load. In the process of these plates bending the energy is dissipated allowing the ATM cabinet and the energy dissipation assembly remains somewhat intact. Energy absorbed by the energy dissipation assembly also reduces the energy levels appearing at the expander bolt fixing points 25 and 26.

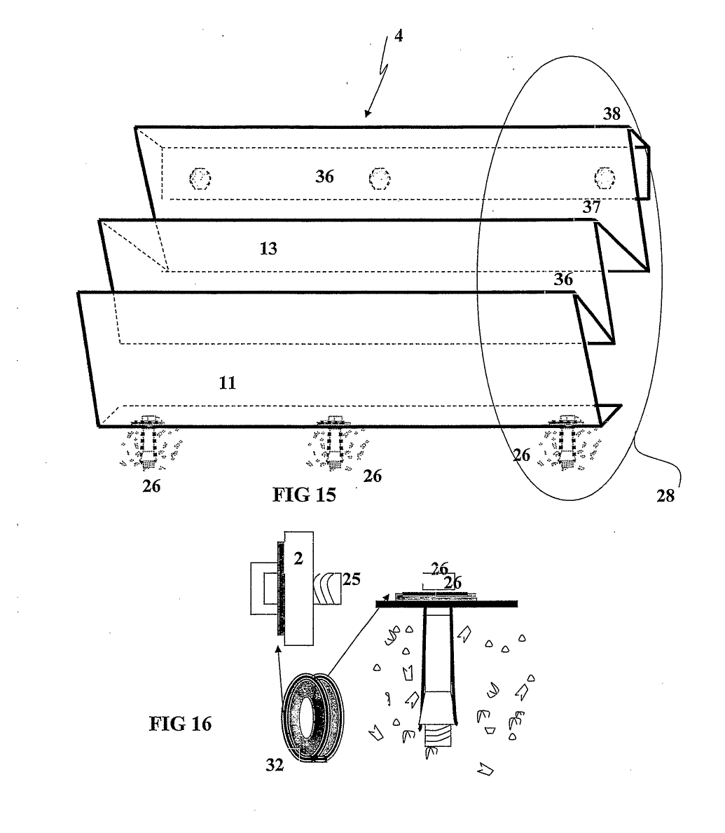

FIG. 15 shows a side view of the energy dissipation assembly 4 after being expanded as described in FIG. 14 with corresponding numbering. The inner plates have bent out from their original shape as shown in FIG. 13. The energy required to do this is the reason the energy dissipation assembly 4 can keep the fixings 25 and 26 from disengaging. The amount of energy absorbed and dissipated is dependant on the type of inner of material making up the plates, the number of folds, the size and structure of the energy dissipation assembly.

FIG. 16 shows a typical expansion bolt in ground 31, In this example a small compression washer 32 made of a nylon or rubber type compound is used. This is fitted to assist in separation of the two surfaces of ground 31 and energy dissipation assembly and the head of the bolt 25 which attached to the ground 31. This aids in reducing the transferring of shock energy from a vehicle coming from ATM 2 and into the ‘ram raid energy absorbing devise’ 3 through into the expansion bolt 26 and hole in ground 31.

A compression washer made of a nylon or rubber type compound is also placed between the ATM cabinet 2 of energy dissipation assembly 4 to also separate the components from direct metal to metal contact. This removes the direct energy transference between the ATM 2 with device 4. Bolt 25 joins ATM cabinet 2 and energy dissipation assembly. The nylon washer separates the two sides from having direct metal to metal contact so to reduce energy transfer.

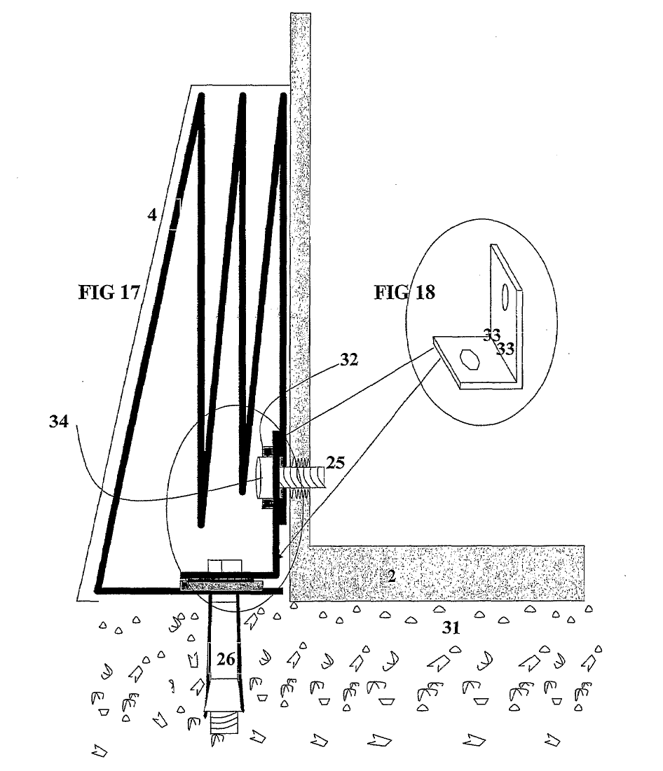

FIG. 17 shows how the energy dissipation assembly 4 covered by cover 3, is fixed to the ATM body 2 with the bolt 25 and washer 32 and ground anchor 26.

FIG. 18 shows a security bracket 33 which is used to cover and secure the ground expansion bolt 26. By fixing using the bolt 26 holding the ATM cabinet the ability to remove the expansion bolt with tools is greatly reduced. The bolt 25 used to attached the ATM cabinet 2 to the energy dissipation assembly 4 can be a security bolt 25 or have the drive head cut off or filled with a resin 34 to reduce its use.

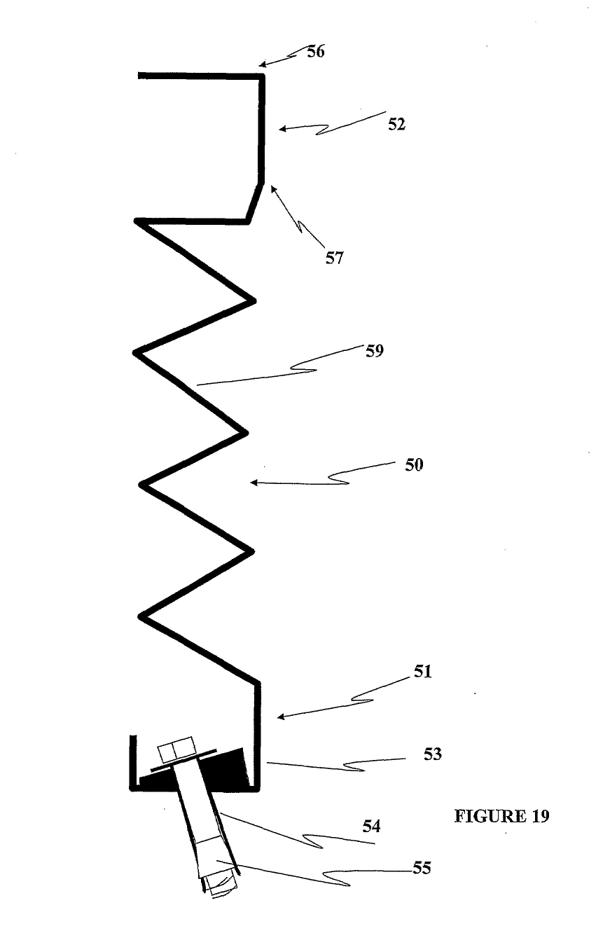

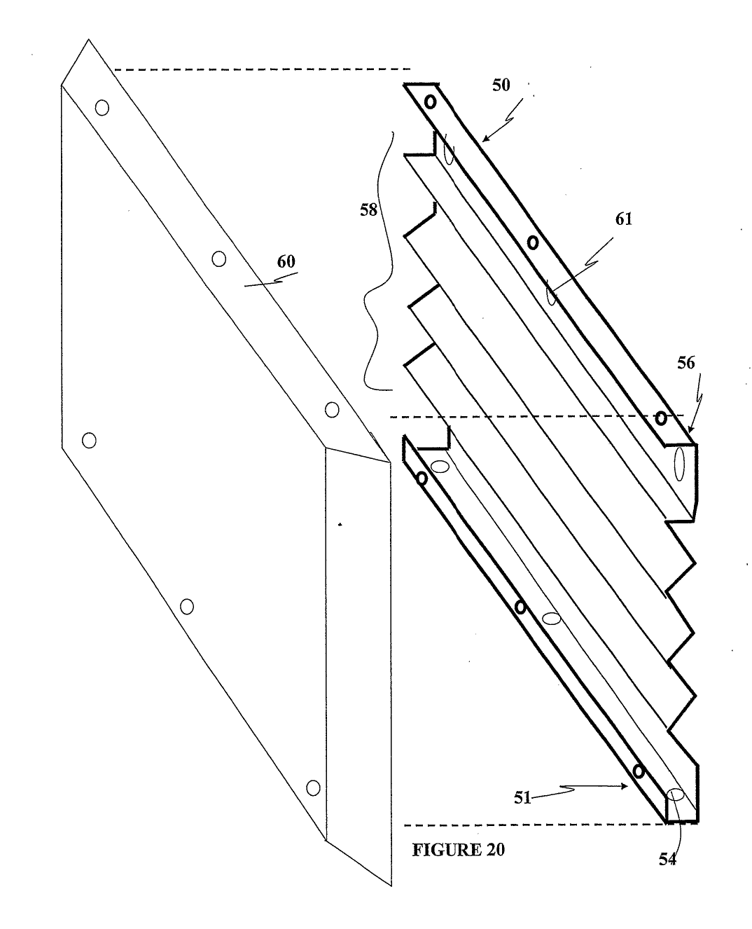

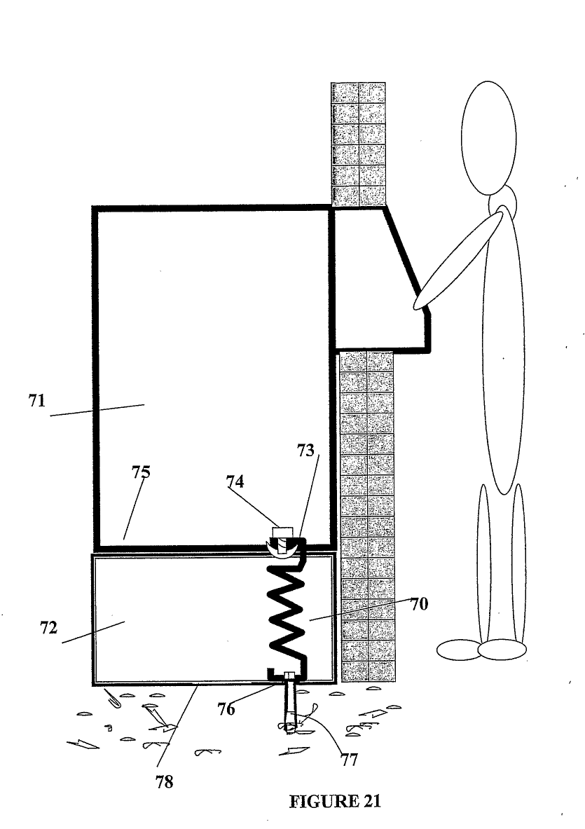

The bracket of FIGS. 19-24 will now be described. FIG. 19 shows an elevation view of a bracket 50 according to a preferred embodiment. Bracket 50 comprises a first end 51 and second end 52. First end 51 includes a channel formation 53 and opening 54 through which a fastener 55 is placed to secure bracket 50 to a ground surface. Fastener 55 may be of the expanding bolt type such as a dynabolt or locksain. Second end 52 comprises a formation 56 including wall 57. Wall 57 preferably includes an opening through which a fastener may be placed to secure end 52 of bracket 50 to a safe ATM or the like. Intermediate ends 51 and 52 there is a region 58 comprising a series of corrugations or ridges and valleys which provides inbuilt capacity for bracket 50 to extend through a number of degrees of freedom including vertically, laterally, rotationally, axially, up or down side to side or a combination of any of the aforesaid degrees of freedom.

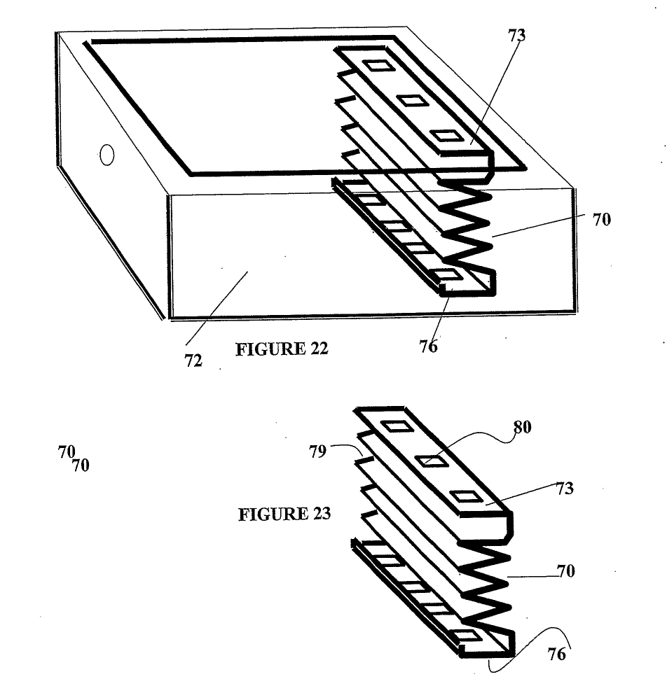

FIG. 20 shows a perspective exploded view of the bracket 50 of FIG. 19 and adjacent cover plate 60. From the perspective view, series of openings 54 of channel 53 can be seen. Also series of openings 61 of wall 57 are seen which receive a fastener for fixation of bracket 50 to an ATM.

FIG. 21 shows a cross sectional elevation view of a connecting bracket assembly 70 connected to an ATM 71 via a plinth 72. According to this embodiment, assembly 70 has a first end 73 connected via fastener 74 to base 75 of ATM. End 76 of assembly 70 receives fastener 77 to secure assembly 70 to base 78 of plinth 72.

Bracket assembly 70 may be manufactured from a flat plate in which are introduced alternate folds such that the overall length of the bracket assembly when fitted to the ATM is at its shortest and in the event that a load is applied to the ATM is capable of undergoing an extension longitudinally, laterally, rotationally or axially. The plate in the above example is a concertina of folded metal of a suitable thickness to create a number of compressed aligned folds forming valleys and troughs which allows expansion or stretching under load by such an event as a vehicle impact on the ATM container. The ATM would typically rotate or be subject to shear force under load in which case the bracket assembly dissipates that energy.

FIG. 22 shows a perspective view of the bracket assembly 70 of FIG. 21 with plinth 72 isolated from the ATM and with corresponding numbering. FIG. 23 shows a perspective view of the bracket assembly 70 of FIG. 21 isolated from the plinth 72. Bracket 70 of FIG. 23 is preferably made from a folded piece or welded or stitched joined pieces of suitable material as shown. In the example bracket assembly 70 shown, a flat plate of suitable thickness undergoes a series of folds forming first and second ends 73 and 76 and intermediate said ends a series of concertina expandable folds 79 compressed during the manufacturing process. End plate 73 includes openings 80 which receive fasteners 74 (see FIG. 21) and end 76 includes openings 81 which receive fasteners 77 (see FIG. 21). This example shows larger access openings for fasteners and to allow tools such as a matching drive socket and bolt head to pass through to connecting points needed to fix the bracket assembly 70 to the ATM body. The number of folds, size, form, fixings, material used and thickness etc. are adjustable to suit the application.

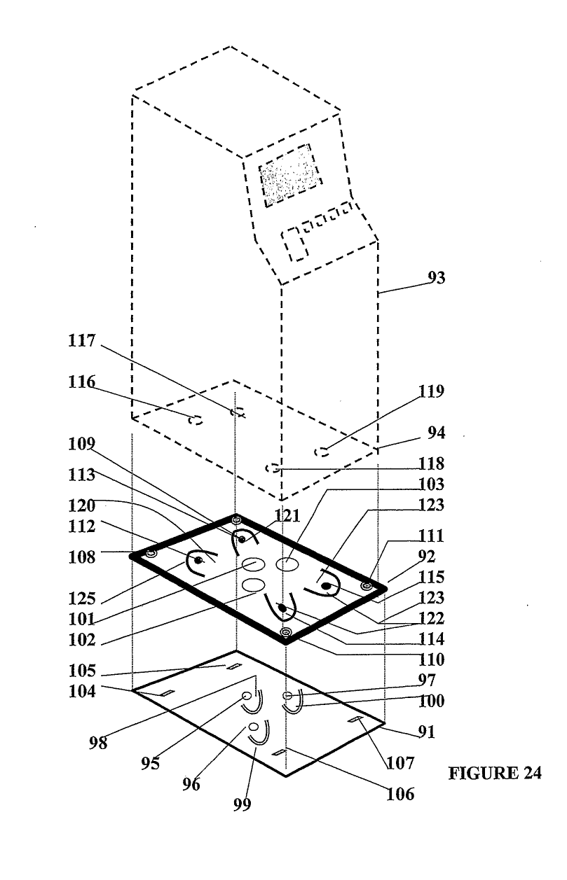

FIG. 24 shows an exploded view of a connecting assembly 90 comprising a first ground engaging plate 91 and second plate 92 which is disposed intermediate the ATM 93 and first plate 91. First plate 2 will normally assume the general shape of a base 94 of the ATM but it will be appreciated by persons skilled in the art that plates 91 and 92 may be a variety of shapes to accommodate the particular installation circumstances. Plate 91 according to the embodiment shown comprises openings 95, 96 and 97 through which fasteners 130 (see FIG. 29) penetrate to secure plate 91 to an anchorage surface such as a concrete slab. Plate 91 includes cut outs which form tabs 98, 99 and 100. These tabs allow plate 91 to undergo displacement when a load such as a rotation is applied to the end of plate 91 which acts as an energy dissipater. Plate 91 also includes fastening points 104, 105, 106, and 107. which oppose corresponding points 108, 109, 110 and 111 on plate 92. Co operating Plate 92 includes openings 101, 102 and 103 which align with openings 95, 96 and 97 in plate 91 allowing access to fasteners 130 (see FIG. 29) when plates 91 and 92 are engaged. Plate 92 includes cut outs which form tabs 120, 121, 122 and 123. These tabs are connected to base 94 of ATM 93 via openings 112, 113, 114 and 115 which receive fasteners which also penetrate openings 116, 117 118 and 119.

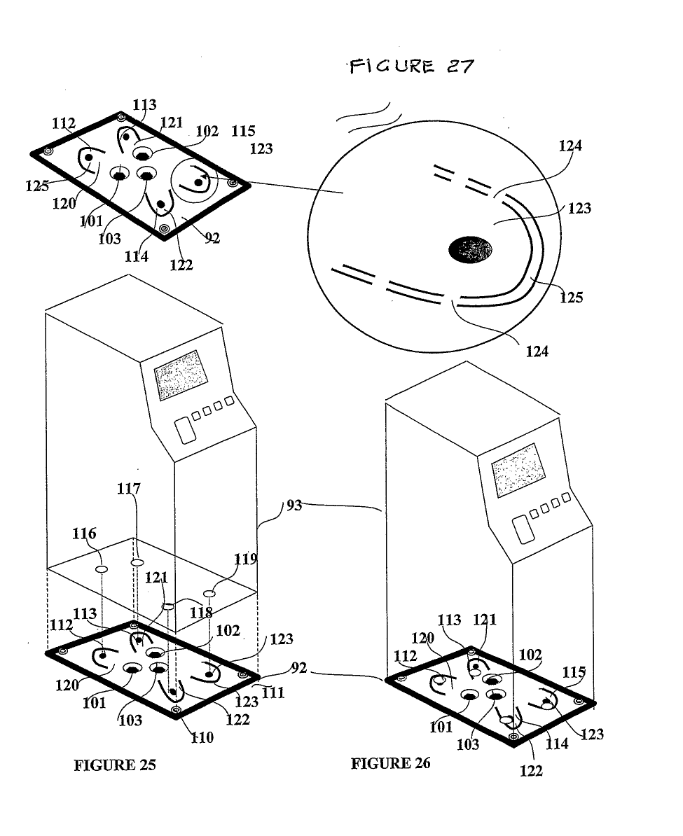

FIG. 25 shows with corresponding numbering the arrangement of FIG. 24 partially assembled with plates 91 and 92 engaged but with ATM 93 isolated. FIG. 26 shows the arrangement of FIG. 25 fully assembled with ATM 93 fully engaged with connecting anchor plates 91 and 92.

FIG. 27 shows an enlarged view of a tab 123. Tab 123 (as with the remaining tabs) each have a series of tear bridges 124 which join tab 123 to plate 92 across cut out 125. In the event of impact load on ATM 93, tear bridges fail allowing tabs connected to ATM 93 to follow the displacement of the ATM. Tear bridges may be lengthened or shortened depending upon the level of resistance required in each installation.

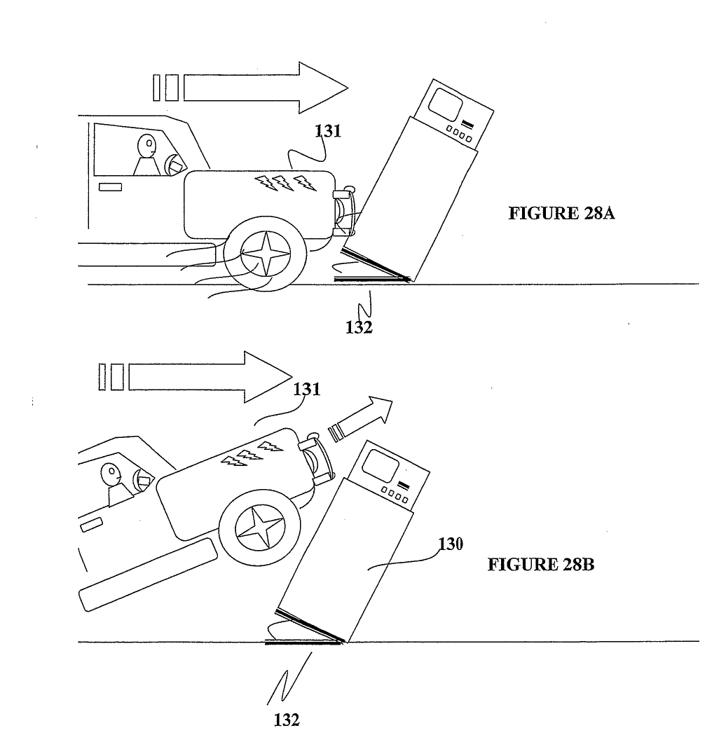

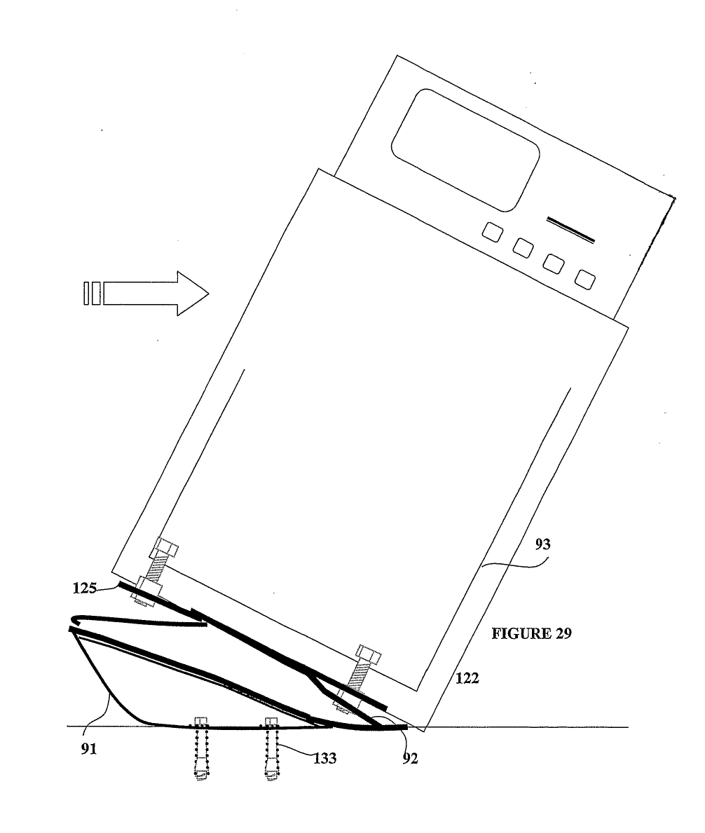

FIGS. 28 A&B shows a front view of an ATM machine 130 reacting to impact load from a vehicle 131 and mode of expansion of the connecting plate assembly 132. In

FIG. 29 shows an enlarged front view of ATM 93 subject to lateral load with connecting plates-schematically under expansion/extension and with corresponding numbering.

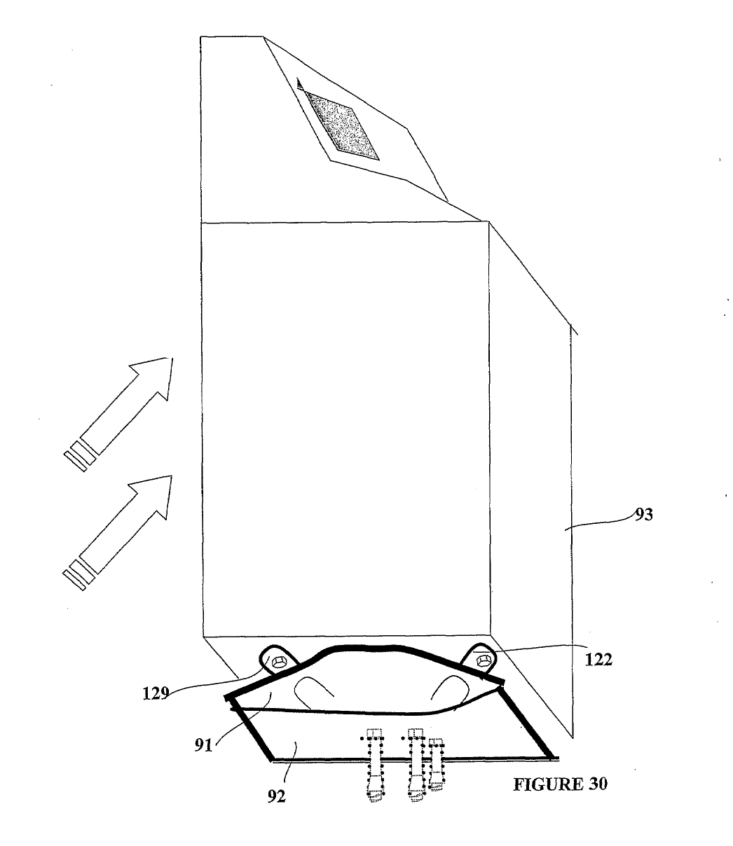

FIG. 30 shows an alternative side view of the arrangement of FIG. 29

This arrangements described above according to various embodiments absorb and dissipate energy created by sudden and repetitive violent impact and leverage created by a vehicle or other high energy equipment. This may be achieved by a variety of geometries such as extension, expansion, elongation, rotation, bending and which induce compression, tension, shear, moment or any combination of the above.

The embodiments show how the assembly may work with an ATM (automatic teller machine). This invention can be used on any type of rigid or soft container such as a vending machine, ticket dispensing machine, gate, door, wall or window frame or any item which might be subjected to a violent physical or explosive attack.

An ATM will be normally bolted down on the ground using 4× expansion bolts. These bolts by their design will keep the ATM container secured to the ground. The mechanical design of these bolts to the ATM body is both rigid and with little or no capacity to flex when violent impact pressure is applied to the cabinet. The bolts attaching the ATM cabinet are only as strong as the size and quality of the bolt hole, expander bolt installation, the material making up the ground material.

Should the pressure applied become greater than the ability of the bolt or ground to contain the pressure, the bolt or the ground will fail, allowing the bolt to release from the ground. It is therefore important that the ground anchorages and connections form the assembly to the ATM are very strong. The connection assembly is installed on the ground and onto the external surface at each side of the cabinet or at any sides deemed open to physical attack. To ensure best security practices additional connection assemblies may be installed where high energy is to be resisted.

The length height and size on the selected connection assembly is based on the size of the container to which it is fitted. The material for the energy dissipation assembly is preferably flexible and high strength such as but not limited to steel with sufficient strength and flexibility to facilitate the action of flexing and expanding without tearing under applied loads. Materials including steel, stainless steel, plastic, resin, aluminum, polymer, fiberglass, any combination of materials or other suitable materials not described may be sued. Material thickness and the folds of the flexing material are adjustable to facilitate the action of flexing and expansion when attacked as described. By creating a concertina of a suitable material this creates a form of mechanical shock absorber with stored plastic or elastic energy.

The effect is to dissipate the energy of impact and to reduce the stresses on the outer fixings, allowing these fixings to remain intact and connected to the ATM body and the ground.

Fitting the fixing bolts or similar to the ground and the ATM body should be carried out in such a way that little or no opportunity is given to extract them when the connection assembly is completely installed.

In one such configuration bolts are fitted between the ATM body and the ground and with a rubber or nylon or similar material washer. Being of a suitable thickness it provides a spongy and flexible separation between each components metal surface. This spongy washer allows for movement and flexing when pressure from a fulcrum or impact pressure being transferred to the other side of the connection to the other. It also allows the two surfaces to flex and to reduce the shock of impact between both surfaces.

Fitting to the ATM body is via screws or bolts into the cabinet of the ATM. Such a bolt can be fitted by providing either a hole of sufficient size in the cabinet as to allow a nut to be fitted inside the cabinet and to then draw the bolt down using a socket or other suitable hand tool. A high tensile bolt of suitable capacity to support this assembly under expected physical load is used employing a threaded hole of matching thread to the bolt into the ATM cabinet steel.

In another example where access to the internal side of the container in restricted, a thread is tapped into the ATM body material and a high tensile ‘hex’ head bolt is then wound onto the thread fixing the assembly onto the ATM cabinet. A ‘hex’ is then filled with a suitable resin or two part hardening putty to prevent and matching tool the ability to draw the bolt out.

Once the ‘ram raid energy absorbing devise’ has been correctly installed a cover plate is fixed, using fixing screws to ensure that it does not cause any opportunities of injuring the users of the ATM. In all appearances it looks like a skirting board and is best shown in FIG. 1. This also allows the components to be secure from damage from cleaning machines or collecting of foreign material or tampering which may impede the performance of energy dissipating connection assembly.

The energy dissipating assembly is deformed during an impact on an article held by the assembly. The deformation allows gradual energy dissipation.

FIGS. 10 and 28 A &B show a vehicle impact to an ATM from the side which has rotated/tilted the ATM cabinet. The inner plates of the energy dissipating assembly are forced upward and in this process they are absorbing the energy of the impact. The plates are folded metal of a suitable thickness and as the energy stored by the folding together is expelled over the distance of by and through the expansion of inner plates.

While the expansion bolts on the inside of the ATM container received the full force of the impact through the rigid body shell, they are subject to the disengaging from the ground. The expander bolts holding the assembly on the side where the vehicle has hit receives a smaller portion of the energy expelled from the impact.

Should the impact be repeated the flexing plates would again reduce the impact pressure on the bolts. The assembly on the opposite side of the ATM container would also receive energy from the impact. The present invention provides a plurality of alternate constructions which can be adopted to achieve the desired results and capabilities. In this disclosure, non limiting examples are shown.

It will be recognized by persons skilled in the art that numerous variations and modifications may be made to the invention as broadly described herein without departing form the overall spirit and scope of the invention.

1. An assembly for securing an article to a surface, the assembly comprising:
at least one connecting member each including means at a first location to secure said member to said surface and means at a second location to secure said member to said article;
the connecting member having means to dissipate energy in the event of a load applied to said article, the energy dissipation means allowing the at least one connecting member to extend under said impact thereby restraining the article from separation from said connecting member.

2. An assembly according to claim 1 wherein each connecting member moves upon an impact load on said article between a first state in which the connecting member is unextended and a second state in which the connecting member is extended in at least one direction as said article moves.

3. An assembly according to claim 2 wherein, each said at least one connecting member is fastened at the first location to a ground surface and via said second location to said article via at least one fastener.

4. An assembly according to claim 3 wherein the at least one connecting member deforms on application of a load to said article.

5. An assembly according to claim 4 wherein the connecting member comprises at least one bracket having a first end connected to the ground and a second end connected to the article.

6. An assembly according to claim 5 wherein each said brackets include formations intermediate said first and second ends which allow said brackets to deform under load applied to said article.

7. An assembly according to claim 6 wherein the formations comprises a series of corrugations between said first and second ends of each said at least one bracket.

8. An assembly according to claim 7 wherein the formations comprise, at least one V formation intermediate opposite ends of each said brackets.

9. An assembly according to claim 8 wherein, the bracket is capable of a displacement in a direction which allows a rotation of the article away from a line of applied load.

10. An assembly according to claim 9 wherein the bracket is capable of concurrent displacement vertically, rotationally and laterally.

11. An assembly according to claim 10 wherein each bracket has a first end plate which connects the bracket to the ground surface, a second end plate which connected said bracket to the article and a plurality of aligned folds therebetween, the folds allowing the bracket to extend from a first length to a plurality of longer lengths responsive to load.

12. An assembly according to claim 4 wherein the connecting member is at least one plate.

13. An assembly according to claim 12 wherein the connecting member includes a ground engaging plate.

14. An assembly according to claim 13 wherein the ground engaging plate has at least one tab which forms a deformable portion of the plate and which allows the plate to move out of the plane of the plate when an impact load is applied to the article.

15. An assembly according to claim 14 wherein the plate includes openings to receive fasteners for securing said plate to said ground surface.

16. An assembly according to claim 15 wherein the plate has means to allow connection to an adjacent second plate.

17. An assembly according to claim 16 wherein said second plate has at least one tab which forms a deformable portion of the plate and which allows the tab to move out of the plane of said the plate when an impact load is applied to the article.

18. An assembly according to claim 17 wherein the second plate includes openings for access to fasteners for securing said first plate to said ground surface.

19. An assembly according to claim 17 wherein the second plate further includes at least one tear bridge disposed in a cut our adjacent each said tabs.

20. An assembly according to claim 19 wherein the tabs of said second plate each include an opening which receive a fastener which engages a corresponding opening in the article to which said second plate is attached.

21. An assembly according to claim 20 wherein, the first plate moves relative to the ground surface when the article is under load.

22. An assembly according to claim 21 wherein the article moves relative to the second plate under applied load.

23. An assembly according to claim 22 wherein the fasteners are expandable bolts.

24. An assembly according to claim 23 wherein the fasteners are disposed in parallel planes or in vertical alignment.

25. An assembly according to claim 24 wherein the article is an automatic teller machine.

26. An assembly according to claim 4 wherein the connecting member is a helical spiral.

27. An assembly for dissipating energy generated by a force applied to an article fixed to a ground surface via the assembly, the assembly comprising
at least one connecting member having a first part which is fastened to the ground surface,
at least a second part fixed to said device,
the connecting member including means to enable the member to expand along at least one dimension in the event of an impact load applied to the article to which it is attached; said expansion means allowing dissipation of energy generated by a loading to the device; thereby restraining the device from separation from said at least one connecting member.

28. (canceled)

29. An energy absorbing bracket for dissipating energy generated by a force applied to an article fixed to a ground surface by the bracket, the bracket comprising
a first part at one end which is fastened to the ground surface,
a second part at a second end fixed to said device,
the bracket including means to enable the bracket to displace along at least one if its dimensions in the event of an impact load applied to the article secured by the bracket; said displacement allowing dissipation of energy generated by a loading to the article; thereby restraining the article from separation from the bracket and from said ground surface.

30-42. (canceled)
